(19) United States
(12) Patent Application Publication
(10) Pub. No.: US 2006/0221307 A1
(43) Pub. Date: Oct. 5, 2006

(54) Image projecting apparatus

(75) Inventors: Masayuki Imaoka, Izumiotsu-shi (JP); Atsushi Matsuura, Sakai-shi (JP)

Correspondence Address: SIDLEY AUSTIN LLP, 717 NORTH HARWOOD, SUITE 3400, DALLAS, TX, 75201, US

(73) Assignee: KONICA MINOLTA OPTO, INC.

(21) Appl. No.: 11/385,149

(22) Filed: Mar. 21, 2006

(30) Foreign Application Priority Data
Mar. 29, 2005 (JP) 2005-093759

(51) Int. Cl. G03B 21/22

(52) U.S. Cl. 353/78

(57) ABSTRACT

An image projecting apparatus includes a projecting optical system having a curved reflection surface on a side closest to a screen on an optical path thereof, a first plane mirror for reflecting the image light emitted from the projecting optical system, a second plane mirror for reflecting the image light reflected by the first plane mirror, a first light shielding member arranged between the reflection type optical element and the second plane mirror, and a second light shielding member arranged between the first plane mirror and the screen.

This application is based on the application No. 2005-093759 filed in Japan Mar. 29, 2005, the entire content of which is hereby incorporated by reference.

### BACKGROUND OF THE INVENTION

1. Field of the Invention

The present invention relates to an image projecting apparatus that projects an image onto a screen. Particularly, the invention relates to the image projecting apparatus that sequentially reflects image light emitted from a projecting optical system by means of two plane mirrors so as to lead the image light to the screen.

2. Description of the Related Art

Conventionally, various apparatuses that project an image onto a screen using a projecting optical system and two plane mirrors are proposed. For example, FIG. 7 illustrates a schematic constitution of an image projecting apparatus disclosed in Japanese Patent Application Laid-Open No. 5-241239. This apparatus has a prism 101 of a projecting optical system, a first plane mirror 102, a second plane mirror 103, a light shielding plate 104, and a screen 105.

The prism 101 rotates an image copied on a microfilm on the screen 105, and is provided below the screen 105. The first plane mirror 102 is provided above the screen 105, namely, to an opposite side to the prism 101 with respect to the screen 105. The second plane mirror 103 is provided to such a position so as to approximately face to the screen 105. The light shielding plate 104 shields unnecessary light other than image projected light, and is provided movably to light which transmits through the prism 101. The light shielding plate 104 is moved forward and backward by a moving unit (not shown) according to rotation of the prism 101.

In this constitution, the light (projection light) which transmits through the prism 101 is sequentially reflected by the first plane mirror 102 and the second plane mirror 103, and is emitted to a rear side of the screen 105 at a small incident angle. At this time, harmful light of the projection light transmitting through the prism 101, which reaches the rear surface (projection surface) of the screen 105 according to a rotational angle of the prism 101, is shielded by the light shielding plate 104, so that a deterioration in visibility of the image to be projected onto the screen 105 is avoided.

In recent years, the demands on slim-profile and weight saving of image projecting apparatuses increase. Such slim-profile and lightweight image projecting apparatuses can be realized by a constitution, for example, where a compact wider-angle projecting optical system is used, and light emitted from the projecting optical system is allowed to enter the screen via the two plane mirrors from an oblique direction (at comparatively large incident angle).

The above projecting optical system can be realized by, for example, arranging a curved reflection surface (for example, curved mirror) on an optical path of the projecting optical system on a side closest to the screen. The oblique projection can be realized by, for example, arranging the first plane mirror on a side closer to the projecting optical system with respect to the screen, whereas arranging the second plane mirror so as to be approximately opposed to both the first plane mirror and the screen.

In the case where the curved mirror is arranged on the side which is the closest to the screen in the projecting optical system, it is difficult to restrict light flux like the case using a projection lens from the viewpoint of optical design. For this reason, light in the light emitted from the curved mirror which does not enter the first plane mirror but directly enters the screen (hereinafter, referred to as ghost light) is also present. When the ghost light enters the screen, since the quality of the image to be projected regularly onto the screen via the second plane mirror is deteriorated, it is necessary to cut the ghost light in an appropriate position.

A constitution where the ghost light is cut by the image projecting apparatus that performs oblique projection using the wide-angle projecting optical system is not realized yet. The apparatus in Japanese Patent Application Laid-Open No. 5-241239 cuts ghost light in the constitution such that the first plane mirror 102 is provided to the side opposite to the projecting optical system (prism 101) with respect to the screen 105. The basic constitution of this apparatus is different from that of the slim-profile and lightweight image projecting apparatuses where the first plane mirror is provided to the side of the projecting optical system with respect to the screen. Even if, therefore, the light shielding plate that cuts the ghost light is provided into the image projecting apparatus, an arrangement position of the light shielding plate should be considered. The arrangement way of the light shielding plate 104 in Japanese Patent Application Laid-Open No. 5-241239 cannot be directly applied to the above slim-profile and lightweight image projecting apparatus.

### SUMMARY OF THE INVENTION

It is an object of the present invention to provide an image projecting apparatus that cuts ghost light in an appropriate position so as to be capable of avoiding a deterioration in the quality of an image to be projected onto a screen in a constitution where a projecting optical system and two plane mirrors are used so as to perform oblique projection onto the screen.

According to a first aspect of the present invention, an image projecting apparatus of the present invention includes: a projecting optical system for emitting an image light to a screen, including a reflection type optical element having a curved reflection surface on a side closest to the screen on an optical path thereof; a first plane mirror for reflecting the image light emitted from the projecting optical system so as to lead the image light to the screen; a second plane mirror arranged on an optical path of the first plane mirror on the screen side for reflecting the image light reflected by the first plane mirror; and a light shielding member arranged between the reflection type optical element and the second plane mirror for shielding a light unnecessary for an image projection.

According to a second aspect of the present invention, an image projecting apparatus includes: a projecting optical system for emitting an image light to a screen, including a reflection type optical element having a curved reflection surface on a side which is the closest to the screen on an optical path thereof; a first plane mirror for reflecting the image light emitted from the projecting optical system so as to lead the reflected light to the screen; a second plane mirror for reflecting the image light reflected by the first plane mirror, arranged on an optical path of the first plane mirror on the screen side; and a light shielding member arranged between the first plane mirror and the screen for shielding light unnecessary for image projection.

According to a third aspect of the present invention, an image projecting apparatus comprising: a projecting optical system for emitting an image light including a reflection type optical element having a curved reflection surface on a side which is the closest to a screen on an optical path thereof; a first plane mirror for reflecting the image light emitted from the projecting optical system so as to lead the reflected light to the screen; a second plane mirror arranged on an optical path of the first plane mirror on the screen side for reflecting the image light reflected by the first plane mirror; a first light shielding member arranged between the reflection type optical element and the second plane mirror for shielding light unnecessary for image projection; and a second light shielding member arranged between the first plane mirror and the screen for shielding light unnecessary for image projection.

According to these constitutions of the image projecting apparatus, the image light emitted from the projecting optical system is reflected sequentially by the first plane mirror and the second plane mirror (its optical path is bent sequentially) so as to be projected onto the screen.

At this time, since the first plane mirror is arranged on the side closer to the projecting optical system with respect to the screen, for example, the second plane mirror can be arranged so as to have a portion which is approximately opposed to both the first plane mirror and the screen. As a result, the image light emitted from the projecting optical system is reflected sequentially by the first plane mirror and the second plane mirror, so as to advance from the projecting optical system to the screen in a zigzag way. That is to say, the optical path from the projecting optical system to the first plane mirror does not overlap with the optical path from the second plane mirror to the screen. In this constitution, therefore, the image light can be allowed to enter the screen at a comparatively larger incident angle from an oblique direction.

Since the projecting optical system has the reflection type optical element having the curved reflection surface on the side which is the closest to the first plane mirror on the optical path, the compact and wider-angle projecting optical system can be easily realized.

Since the image projecting apparatus of the present invention has the constitution where the oblique projection is performed by using the compact and wider-angle projecting optical system, slim-profile and weight saving of the apparatus can be easily realized.

Further, the light shielding member is provided at least one of between the reflection type optical element and the second plane mirror and between the first plane mirror and the screen. The light shielding member cuts light unnecessary for image projection. The light unnecessary for image projection is light (ghost light) which deteriorates quality of a regular image to be projected onto the screen from the projecting optical system via the first plane mirror and the second plane mirror when this light enters the screen.

As such ghost light, for example, the following can be considered. That is to say, firstly, it is light (hereinafter, referred to also as first ghost light) which deviates from the optical path where the image light emitted from the curved reflection surface of the reflection type optical element enters the first plane mirror so as to enter the screen directly. Secondly, it is light (hereinafter, referred to also as second ghost light) which is emitted from the curved reflection surface of the reflection type optical element and is reflected sequentially by an end of the first plane mirror opposite to the screen, and a corner or an end of the second plane mirror on the side of the reflection type optical element so as to reach the screen. Thirdly, it is light (hereinafter, referred to also as third ghost light) which is emitted from the curved reflection surface of the reflection type optical element and is reflected by an end of the first plane mirror on the side of the screen and a corner or an end of the second plane mirror opposite to the reflection type optical element so as to reach the screen. The other various ghost light could be present.

In the present invention, however, since the light shielding member is provided in at least one position, even in the constitution where the slim-profile and lightweight apparatus can be realized, the ghost light which exerts a bad influence on the projected image can be suitably cut by the light shielding member. As a result, the deterioration in the quality of the projected image can be avoided.

Particularly in the constitution where the light shielding member is provided both between the reflection type optical element and the second plane mirror and between the first plane mirror and the screen, for example, the ghost light which cannot be cut by one light shielding member can be occasionally cut by the other light shielding member. As a result, the deterioration in the quality of the projected image can be avoided securely.

In the constitution where two plane mirrors (first plane mirror and second plane mirror) fold the optical path, the first ghost light is easily generated. That is to say, in the image light emitted from the curved reflection surface of the projecting optical system, the light which deviates from the optical path entering the first plane mirror so as to enter the screen directly is easily generated. It is desirable that the light shielding member, however, shields at least the first ghost light.

In the image projecting apparatus of the present invention, in the image light which enters the screen from the curved reflection surface via the first plane mirror and the second plane mirror, the light which enters the screen on the side which is the closest to the first plane mirror is a first light, and the light which enters the screen on the opposite side to the first plane mirror is a second light. It is desirable that the light shielding member which is provided between the reflection type optical element and the second plane mirror is provided outside the optical path with respect to a position where the light advancing from the first plane mirror to the second plane mirror in the first light intersects with the light advancing from the curved reflection surface to the first plane mirror in the second light.

At least the second ghost light is possibly present outside the optical path of the first light in the light flux advancing from the first plane mirror to the second plane mirror. On the other hand, the first ghost light is possibly present outside the optical path of the second light in the light flux advancing from the curved reflection surface of the reflection type optical element to the first plane mirror. Both the first ghost light and the second ghost light deteriorate the quality of the image to be regularly projected onto the screen via the second plane mirror.

The light shielding member provided between the reflection type optical element and the second plane mirror is provided outside the optical path with respect to a position where the first light advancing from the first plane mirror to the second plane mirror intersects with the second light advancing from the curved reflection surface of the reflection type optical element to the first plane mirror. As a result, both the first ghost light and the second ghost light can be cut efficiently by one light shielding member.

At this time, when the light shielding member is provided on the side which is the closest to the first plane mirror (the outside of the optical path with respect to the intersection position and in a position which is the closest to the intersection position), an effect for cutting both the first ghost light and the second ghost light can be obtained maximally.

In the image projecting apparatus of the present invention, in the image light which enters the screen from the curved reflection surface via the first plane mirror and the second plane mirror, the light which enters the screen on the side which is the closest to the first plane mirror is the first light, and the light which enters the screen on the opposite side to the first plane mirror is the second light. In this case, it is desirable that the light shielding member to be provided between the first plane mirror and the screen is provided outside the optical path with respect to the position where the light advancing from the second plane mirror to the screen in the first light intersects with the light advancing from the first plane mirror to the second plane mirror in the second light.

The first ghost light is possibly present outside the optical path of the first light in the light flux advancing from the second plane mirror to the screen. Meanwhile, at least the third ghost light is possibly present outside the optical path of the second light in the light flux advancing from the first plane mirror to the second plane mirror. Both the first ghost light and the third ghost light deteriorate the quality of the image to be regularly projected onto the screen via the second plane mirror.

The light shielding member to be provided between the first plane mirror and the screen is provided outside the optical path with respect to a position where the first light advancing from the second plane mirror to the screen intersects with the second light advancing from the first plane mirror to the second plane mirror. In this case, both the first ghost light and the third ghost light can be cut efficiently by one light shielding member.

At this time, when the light shielding member is provided on the side which is the closest to the second plane mirror (outside the optical path with respect to the intersection position and a position which is the closest to the intersection position). As a result, the effect for cutting both the first ghost light and the third ghost light can be obtained maximally.

### BRIEF DESCRIPTION OF THE DRAWINGS

These and other objects, advantages and features of the invention will become apparent from the following description thereof taken in conjunction with the preferred embodiments with the reference to the accompanying drawings in which:

FIG. 1 is a sectional view illustrating a schematic constitution of an image projecting apparatus according to one embodiment of the present invention;

FIG. 2 is an explanatory diagram typically illustrating an arrangement of respective light shielding plates in the image projecting apparatus of FIG. 1 when an optical path is developed;

FIG. 3 is a sectional view illustrating a constitution of the image projecting apparatus in FIG. 1 where one light shielding plate is omitted;

FIG. 4 is a sectional view illustrating a constitution of the image projecting apparatus in FIG. 1 where the other light shielding plate is omitted;

FIG. 5 is a sectional view illustrating a schematic constitution of the image projecting apparatus using another projecting optical system according to the present invention;

FIG. 6 is a sectional view illustrating a schematic constitution of the image projecting apparatus using still another projecting optical system according to the present invention; and

FIG. 7 is a sectional view illustrating a schematic constitution of a conventional image projecting apparatus.

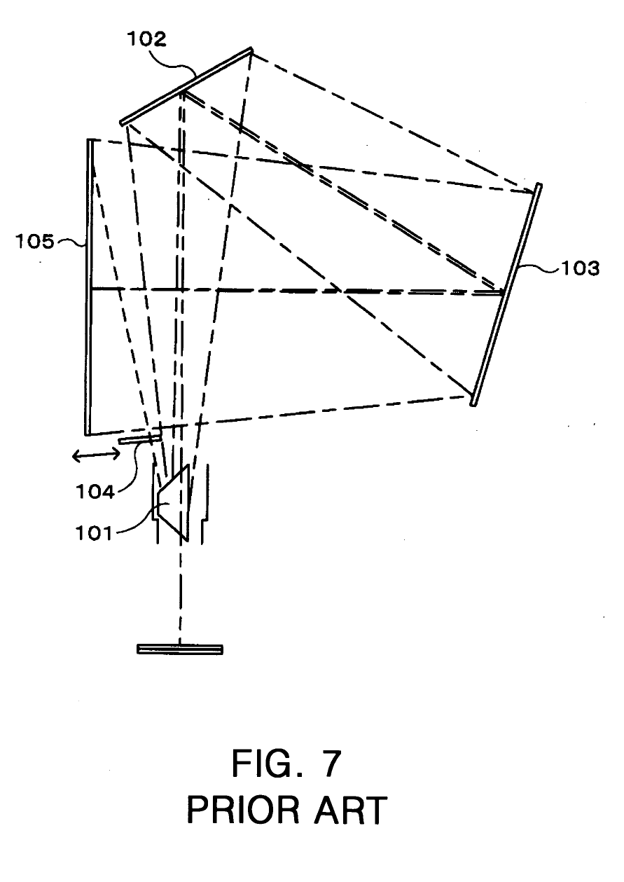

### DETAILED DESCRIPTION OF THE PREFERRED EMBODIMENT

One embodiment of the present invention is explained below with reference to the drawings.

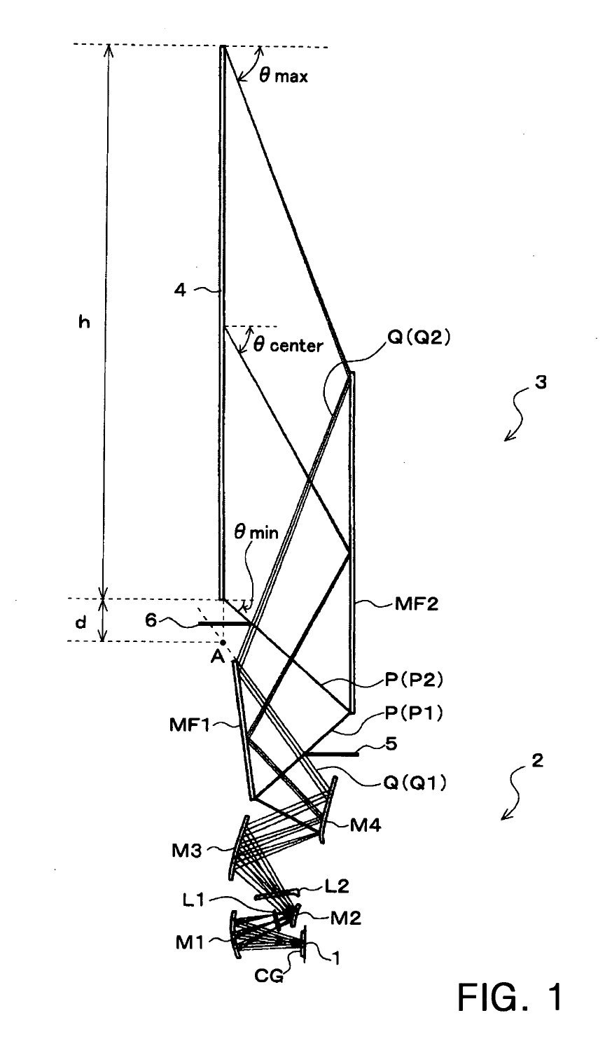

FIG. 1 is a sectional view illustrating a schematic constitution of an image projecting apparatus according to this embodiment. The image projecting apparatus has a light modulating element 1, a projecting optical system 2, an optical path bending portion 3, a screen 4 and light shielding plates 5 and 6. These components compose a rear-projection type image projecting apparatus (rear projector) that performs oblique projection to a projection surface of on an enlargement side (the side of the screen 4) from a reduction side (side of the light modulating element 1).

The following explains the image projecting apparatus where the screen 4 is positioned above the projecting optical system 2, and light advances from bottom to top for convenience of the explanation. Needless to say, the present invention, however, can be applied to an image projecting apparatus where an up-down direction of this embodiment is reversed, and an image projecting apparatus where the up-down direction of this embodiment is replaced by a right-left direction.

The light modulating element 1 modulates incident light according to image data, and supplies light corresponding to a display image (hereinafter, referred to as image light) to the projecting optical system 2. The light modulating element 1 is composed of, for example, DMD (digital micromirror device; manufactured by Texas Instruments Incorporated). A cover glass CG is arranged on a front surface of the light modulating element 1.

The light modulating element 1 is not limited to the DMD, and may be, for example, a transmission or reflection type liquid crystal element or a self-emission type display element. When the self-emission type display element is used as the light modulating element 1, a light source or the like for illumination is not required, and thus an optical constitution can be more lightweight and downsized.

The projecting optical system 2 emits image light formed by the light modulating element 1, and is composed of a plurality of reflection type optical elements (for example, mirrors) and transmission type optical elements (for example, lenses). More specifically, the projecting optical system 2 is composed of a mirror M1, a lens L1, a mirror M2, a lens L2 and mirrors M3 and M4. These optical elements are arranged in this order from the reduction side to the enlargement side.

The mirrors M1 and M2 are composed of curved mirrors having curved reflection surfaces made of spheric surfaces, respectively. The lenses L1 and L2 have a rotationally asymmetrical aspheric surface (so-called, free curved surface) on the reduction side, and are composed of rotationally asymmetrical free curved lenses with approximately no power having a plane on the enlargement side, respectively. The mirrors M3 and M4 are composed of curved mirrors whose reflection surfaces are rotationally asymmetrical free curved surfaces, respectively. The curved reflection surface of the mirror M4 is positioned on the most enlarged side on the optical path of the projecting optical system 2 (on the side of a first plane mirror MF1, mentioned later).

The optical path bending portion 3 bends the optical path of the image light emitted from the curved reflection surface of the mirror M4 in the projecting optical system 2 so as to lead the image light to the screen 4. In this embodiment, the optical path bending portion 3 is composed of the first plane mirror MF1 and a second plane mirror MF2. The first plane mirror MF1 is arranged below the screen 4, namely, on the side of the projecting optical system 2. The second plane mirror MF2 is arranged between an upper end of the screen 4 (an end opposite to the projecting optical system 2) and a lower end of the first plane mirror MF1 (an end on the side of the projecting optical system 2) so as to have a portion approximately opposed to both the screen 4 and the first plane mirror MF1.

The light shielding plates 5 and 6 are light shielding members that shield light which is unnecessary for image projection. The present invention is characterized the most by providing these light shielding plates 5 and 6, but the details are explained later.

According to the above constitution, light from a light source, not shown, enters the light modulating element 1. In the light modulating element 1, the light is reflected by the micromirrors driven by ON/OFF driving according to image data so as to be spacially modulated. At this time, only the light which is reflected by the micromirrors in the ON state enters the projecting optical system 2 as image light.

The image light which enters the projecting optical system 2 enters the optical path bending portion 3 via the mirror M1, the lens L1, the mirror M2, the lens L2, and the mirrors M3 and M4 sequentially. The image light is reflected sequentially by the first plane mirror MF1 and the second plane mirror MF2 of the optical path bending portion 3 so that its optical path is bent and the image light is projected onto the projection surface of the screen 4.

In such a manner, the image light emitted from the projecting optical system 2 is reflected sequentially by the first plane mirror MF1 and the second plane mirror MF2 so as to advance upward from the projecting optical system 2 to the screen 4 in a zig-zag manner. That is to say, the optical path from the projecting optical system 2 to the first plane mirror MF1 and the optical path from the second plane mirror MF2 to the screen 4 are not overlapped with each other. In this constitution, therefore, oblique projection in which the image light enters the screen 4 at a comparatively large incident angle can be easily realized.

In the projecting optical system 2, since the reflection type optical element (mirror M4) having the curved reflection surface on the side closest to the first plane mirror MF1 on the optical path is arranged, the compact and wider-angle projecting optical system 2 can be realized easily. In combination with the oblique projection, therefore, slim-profile and weight saving of the image projecting apparatus can be easily realized.

Details of the light shielding plates 5 and 6 are explained below.

As described above, the light shielding plates 5 and 6 shield light unnecessary for image projection. The light shielding plate 5 is arranged between the mirror M4 and the second plane mirror MF2, and the light shielding plate 6 is arranged between the first plane mirror MF1 and the screen 4. More details of the arrangement of the light shielding plates 5 and 6 are explained later.

The light unnecessary for image projection is ghost light which enters the screen 4 so as to deteriorate the quality of an image to be regularly projected onto the screen 4 from the projecting optical system 2 via the first plane mirror MF1 and the second plane mirror MF2. Such ghost light is as follows.

Firstly, it is light (first ghost light) which deviates from the optical path where the image light emitted from the curved reflection surface of the mirror M4 enters the first plane mirror MF1 so as to enter the screen 4 directly.

Secondly, it is light (second ghost light) which is emitted from the curved reflection surface of the mirror M4 and is reflected sequentially by a lower end of the first plane mirror MF1 (an end opposite to the screen 4), and a lower corner (corner on the side of the mirror M4) or a lower end (an end opposite to the mirror M4) of the second plane mirror MF2 so as to reach the screen 4.

Thirdly, it is light (third ghost light) which is emitted from the curved reflection surface of the mirror M4 and is reflected by an upper end of the first plane mirror MF1 (an end on the side of the screen 4) and an upper corner (corner opposite to the mirror M4) or an upper end (end opposite to the mirror M4) of the second plane mirror MF2 so as to reach the screen 4.

Fourthly, it is light (fourth ghost light) which is emitted from the curved reflection surface of the mirror M4 and is reflected sequentially by an upper corner of the first plane mirror MF1 (corner on the side of the screen 4) and the second plane mirror MF2 so as to reach the screen 4.

Fifthly, it is light (fifth ghost light) which is emitted from the curved reflection surface of the mirror M4 and is reflected sequentially by the lower end of the first plane mirror MF1, the lower end of the second plane mirror MF2, the upper end of the first plane mirror MF1 and the second plane mirror MF2 so as to reach the screen 4.

Sixthly, it is light (sixth ghost light) which is emitted from the curved reflection surface of the mirror M4 and is reflected sequentially by the upper end of the first plane mirror MF1, the upper end of the second plane mirror MF2 and a case inner surface positioned above the screen 4 so as to reach the screen 4.

The upper ends, the upper corners, the lower end and the lower corners of the first plane mirror MF1 and the second plane mirror MF2 are positioned outside an area where the light corresponding to a regular projected image enters on the mirrors. The first to sixth ghost light is one example, and actually various ghost light can be present.

In this embodiment, the light shielding plate 5 is arranged between the mirror M4 and the second plane mirror MF2, and the light shielding plate 6 is arranged between the first plane mirror MF1 and the screen 4 so as to be capable of cut the ghost light (at least one of the above-mentioned ghost light or the other ghost light) which might enter the screen 4. Therefore, the deterioration in the quality of the projected image can be avoided without influencing an image regularly projected onto the screen 4.

Particularly in this embodiment, since the two light shielding plates 5 and 6 are provided, the effect for cutting the ghost light can be obtained more securely than the case where only one light shielding member is provided. As a result, the deterioration in the quality of the projected image can be avoided securely.

In the constitution of this embodiment where the optical path is folded by the two plane mirrors: the first plane mirror MF1; and the second plane mirror MF2, since the first ghost light which enters the screen 4 directly from the curved reflection surface of the mirror M4 is easily generated, the light shielding plates 5 and 6 desirably have the function for shielding at least the first ghost light.

An intersection point between an extended light of the image light entering the upper end of the first plane mirror MF1 (the side closest to the screen 4) from the curved reflection surface of the mirror M4 arranged on the side closest to the first plane mirror MF1 in the projecting optical system 2 and a plane including the projection surface of the screen 4 is designated by A. A shortest distance between the intersection point A and the screen 4 is designated by d, and a length of the screen 4 in the distance d direction is designated by h. The image projecting apparatus in this embodiment is designed so that a value of d/h satisfies the following conditional expression (1):
0.02<d/h<0.5 (1)

Concretely, in this embodiment, d=42.426 (mm), and h=523.272 (mm). Therefore, d/h=0.081, and thus the conditional expression (1) is satisfied.

For example, when the value of d/h is not more than a lower limit value due to too small value of d, the lower end of the screen 4 approaches the first plane mirror MF1. For this reason, a part of the image light emitted from the mirror M4 of the projecting optical system 2 deviates from the optical path entering the first plane mirror MF1 so as to easily enter the screen 4 directly. As a result, the first ghost light increases, and it is necessary to arrange the light shielding plates 5 and 6 that cuts the first ghost light with high accuracy. When the lower end of the screen 4 approaches the first planes mirror MF1, an arrangement space for the light shielding plate 6 between the first plane mirror MF1 and the screen 4 becomes small, and thus a degree of arrangement freedom is deteriorated. On the other hand, when the value of d/h is not less than an upper limit value due to too large value of d, for example, a distance from the lower end of the screen 4 to the lower end of the apparatus which is called as “a chin lower portion” increases.

When the values of d and h are, therefore, set so that the value of d/h falls within the above range, while the certain degree of arrangement freedom is being maintained by relieving the arrangement accuracy of the light shielding plates 5 and 6, an increase in the chin lower portion can be avoided.

As to the incident angle to the screen 4, namely, in an angle between a normal line on the projection surface of the screen 4 and the image light entering the screen 4 from the second plane mirror MF2, the maximum angle is designated by θ max (°), and the minimum angle is designated by θ min (°). The image projecting apparatus in this embodiment is designed so that a value obtained by θ max−θ min satisfies the following conditional expression (2):
10<θ max−θ min<50 (2)

Concretely, in this embodiment, θ max=71.12 (°), and θ min=42.00 (°). Therefore, θ max−θ min=29.12(°), and the conditional expression (2) is satisfied. Incidentally, an incident angle θ of center of the image light entering a center position of the screen 4 in a heightwise direction is 60.97 (°).

In order not to deteriorate the slim-profile of the apparatus for performing oblique projection, it is desirable that the θ min falls within a range of 35 to 57 (°), and θ max falls within a range of 60 to 76(°).

When the value obtained by θ max−θ min is not more than the lower limit value, the optical path necessary for enlarging the screen 4 becomes long, thereby increasing the thickness (width) and the chin lower portion of the apparatus. On the other hand, when the value obtained by θ max−θ min is not less than the upper limit value, the incident angle of the light entering the first plane mirror MF1 from the mirror M4 becomes large, and thus the light emitted from the mirror M4 deviates from the optical path entering the first plane mirror MF1 so as to easily enter the screen 4 directly. As a result, the first ghost light increases, and it is necessary to arrange the light shielding plates 5 and 6 for cutting the first ghost light with high accuracy.

When, therefore, θ max and θ min are set so that the value obtained by θ max−θ min falls within the above range, the increase in the thickness and the chin lower portion of the apparatus can be avoided, and the arrangement accuracy of the light shielding plates 5 and 6 can be relieved.

Details of the arrangement positions of the light shielding plates 5 and 6 are explained below. As to the image light which enters the screen 4 from the curved reflection surface of the mirror M4 via the first plane mirror MF1 and the second plane mirror MF2, the light which enters the lower end of the screen 4, namely, the side of the screen 4 closest to the first plane mirror MF1 is first light P, and the light which enters the upper end of the screen, namely, the opposite side of the screen 4 to the first plane mirror MF1 is second light Q.

In this embodiment, the light shielding plate 5 is provided outside the optical path (projected light flux) with respect to a position where light which advances from the first plane mirror MF1 to the second plane mirror MF2 (hereinafter, referred to as light P1) in the first light P intersects with light which advances from the curved reflection surface of the mirror M4 to the first plane mirror MF1 (hereinafter, referred to as light Q1) in the second light Q. Further, in this embodiment, the light shielding plate 5 is provided outside the optical path (projected light flux) with respect to the position where the light P1 intersects with the light Q1 and in a position which is the closest to the first plane mirror MF1 (position which is the closest to the intersecting position). The reason for it is as follows.

In the light which is emitted from the first plane mirror MF1, the light whose optical path deviates towards the mirror MF4 further than the light P1 includes not only the second ghost light but also the fifth ghost light. Meanwhile, in the light which is emitted from the curved reflection surface of the mirror M4, the light whose optical path deviates towards the screen 4 further than the light Q1 includes not only the first ghost light but also the third, fourth and sixth ghost light.

When, therefore, the light shielding plate 5 is provided outside the optical path with respect to the intersecting position of the light P1 and the light Q1, both the first ghost light and the second ghost light can be cut by the light shielding plate 5. The light on the outsides of the optical paths of the light P1 and the light Q1 to be the other ghost light can be also cut, so that the deterioration in the quality of the projected image can be avoided. Further, various ghost light including the first ghost light and the second ghost light can be cut efficiently by the one light shielding plate 5. Particularly in this embodiment, since the light shielding plate 5 is provided outside the optical path with respect to the intersecting position and on the side which is the closest to the first plane mirror MF1, its effect can be obtained maximally.

On the other hand, the light shielding plate 6 is provided outside an optical path (projected light flux) with respect to a position where light which advances from the second plane mirror MF2 to the screen 4 (hereinafter, referred to as light P2) in the first light P intersects with light which advances from the first plane mirror MF1 to the second plane mirror MF2 (hereinafter, referred to as light Q2) in the second light Q. Further, in this embodiment, the light shielding plate 6 is provided outside the optical path (projected light flux) with respect to the position where the light P2 and the light Q2 intersect with each other and in the position which is the closest to the second plane mirror MF2 (position which is the closest to the intersecting position). The reason for it is as follows.

Not only the first ghost light but also the third and sixth ghost light can be present on the outside of the optical path with respect to the light P2 in the light which is emitted from the second plane mirror MF2 and the outside of the optical path with respect to the light Q2 in the light which is emitted from the first plane mirror MF1.

When, therefore, the light shielding plate 6 is arranged on the outside of the optical path with respect to the intersecting position between the light P2 and the light Q2, both the first ghost light and the third ghost light can be cut by the light shielding plate 6. Further, the light on the outsides of the optical paths of the light P2 and the light Q2 to be the other ghost light can be also cut. As a result, the deterioration in the quality of the projected image can be avoided. Further, various ghost light including the first ghost light and the third ghost light can be cut efficiently by one light shielding plate 6. Particularly in this embodiment, since the light shielding plate 6 is provided on the outside of the optical path with respect to the intersecting position and in the position which is the closest to the second plane mirror MF2, its effect can be obtained maximally.

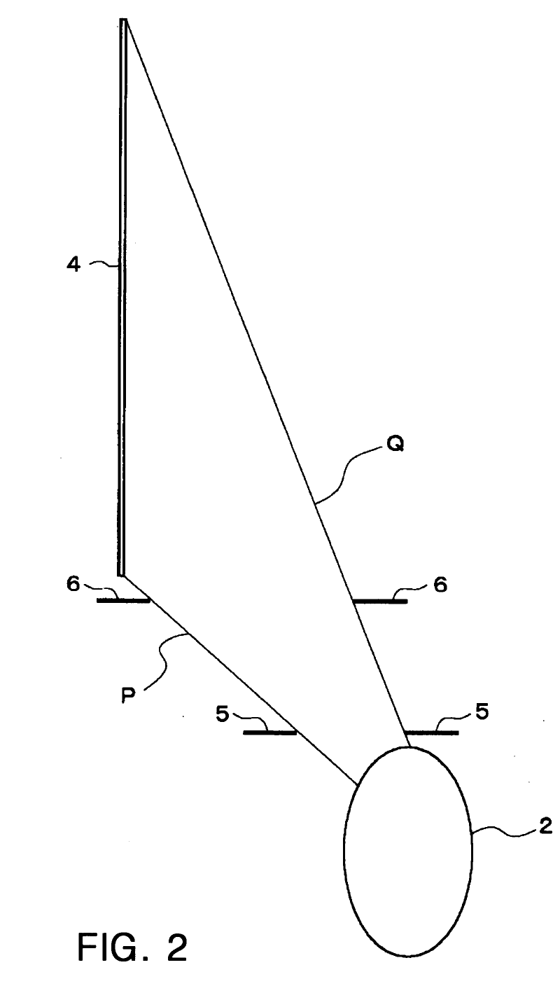

FIG. 2 is an explanatory diagram typically illustrating the arrangements of the light shielding plates 5 and 6 when the optical path is developed in the image projecting apparatus of this embodiment. Since the two light shielding plates 5 and 6 are arranged in two places as mentioned above, the light on the outside of the optical path with respect to the first light P to be led from the projecting optical system 2 to the screen 4 (various ghost light which exerts a bad influence on the projected image) can be cut by the light shielding plates 5 and 6. Simultaneously, the light on the outside of the optical path with respect to the second light Q (various ghost light which exerts a bad influence on the projected image) can be cut by the light shielding plates 5 and 6.

That is to say, in this embodiment, when the optical path bending portion 3 is composed of the two plane mirrors (the first plane mirror MF1 and the second plane mirror MF2), only the arrangement of the light shielding plates 5 and 6 in two places is equivalent to restriction of the light flux in totally four places. From such a viewpoint, therefore, in the constitution using two plane mirrors for bending the optical path, it can be said that various ghost light can be cut efficiently by using the two light shielding plates 5 and 6 even if a number of parts is small.

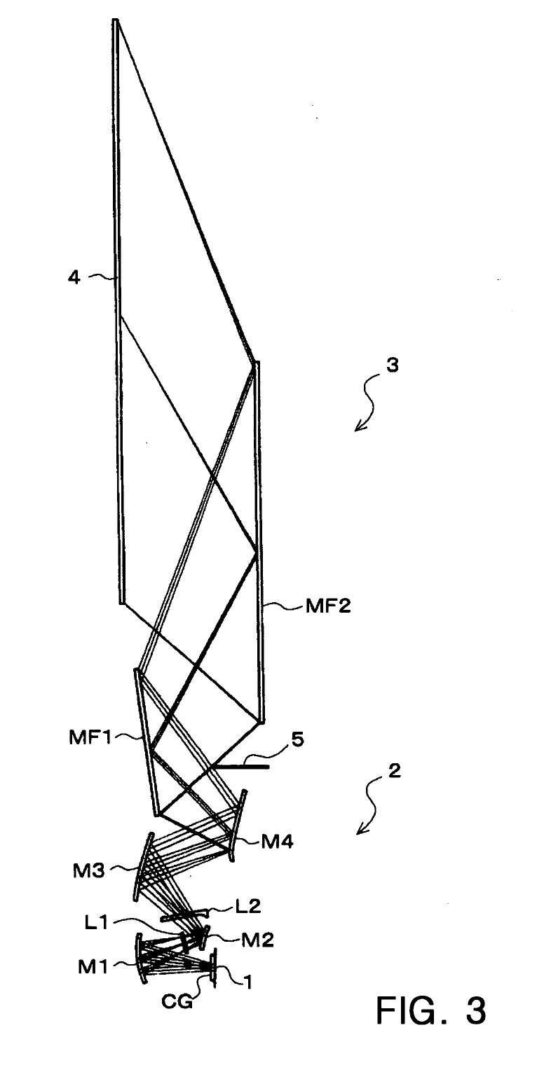

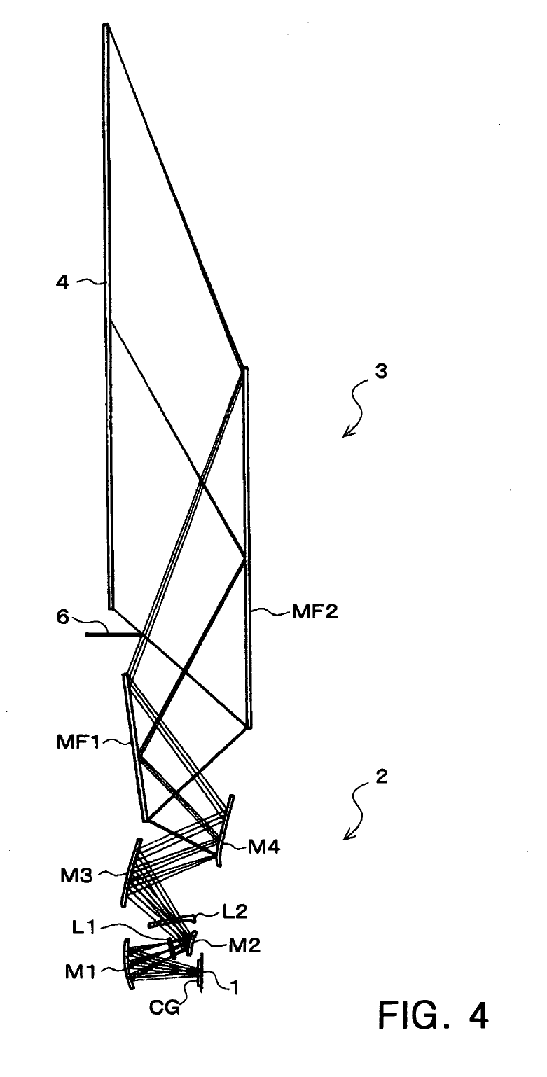

This embodiment explains the constitution using the two light shielding plates 5 and 6, but only one light shielding member may be used. That is to say, as shown in FIG. 3, the light shielding plate 6 is omitted but only the light shielding plate 5 may be arranged. On the contrary, as shown in FIG. 4, the light shielding plate 5 is omitted but only the light shielding plate 6 may be arranged. In these cases, various ghost light can be cut by the light shielding plate 5 or 6, and thus the fact remains that the deterioration in the quality of the projected image can be avoided. When only the light shielding plate 5 or only the light shielding plate 6 is used, the ghost light is cut with the less number of parts (one light shielding member) and the deterioration in the quality of the projected image can be avoided.

The fifth ghost, for example, in the above-mentioned ghost light can be cut by the light shielding plate 5 but cannot be cut by the light shielding plate 6. When, therefore, the fifth ghost light is desired to be cut securely, the constitutions in FIGS. 1 and 3 where the light shielding plate 5 is provided is more preferable than the constitution in FIG. 4 where only the light shielding plate 6 is provided.

The position where the light shielding plate 5 is provided may be, for example, a position which is on the outside of the optical path with respect to the intersecting position between the light P1 and the light Q1 and shifts to the mirror M4 or the second plane mirror MF2 with respect to the intersecting position as long as this position is between the mirror M4 and the second plane mirror MF2. Similarly, the position where the light shielding plate 6 is provided may be, for example, a position which is the outside of the optical path with respect to the intersecting position between the light P2 and the light Q2 and shifts to the screen 4 or the first plane mirror MF1 with respect to the intersecting position as long as the position is between the first plane mirror MF1 and the screen 4. In these cases, the effect such that the ghost light which exerts a bad influence on the regular projected image can be cut by the light shielding plate 5 or 6 cannot be maximally obtained, but these cases are effective for that even only a part of the ghost light can be cut.

This embodiment explains the constitution where the projecting optical system has four mirrors (mirrors M1 to M4), but the constitution may be such that the projecting optical system has two mirrors or only one mirror.

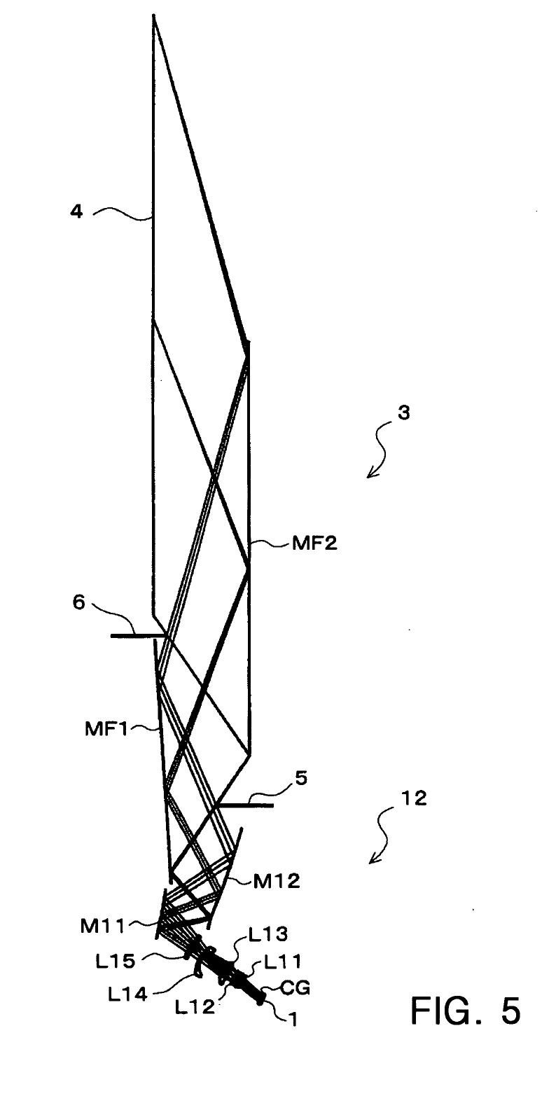

For example, FIG. 5 is a sectional view illustrating a schematic constitution of the image projecting apparatus using a projecting optical system 12 having two mirrors instead of the projecting optical system 2 having four mirrors. The projecting optical system 12 has lenses L11, L12, L13, L14 and L15 as transmission type optical elements, and mirrors M11 and 12 as reflection type optical elements in this order from the reduction side. A diaphragm (not shown) is arranged between the lenses L11 and L12.

The lens L11 is a rotationally symmetrical aspheric lens. The lens L12 is a cemented lens where a negative lens and a positive lens are cemented. The lens L13 is a positive lens, and the lens L14 is a negative lens. The lens L15 is a rotationally asymmetrical aspheric lens with approximately no power. The mirror M11 is a mirror having the curved reflection surface composed of a rotationally symmetrical aspheric surface, and the mirror M12 is a mirror having the curved reflection surface composed of a rotationally asymmetrical aspheric surface. In such a projecting optical system 12, the curved reflection surface of the mirror M12 is positioned on the side which is the closest to the optical path bending portion 3 on the optical path of the projecting optical system 12 (the side of the first plane mirror MF1).

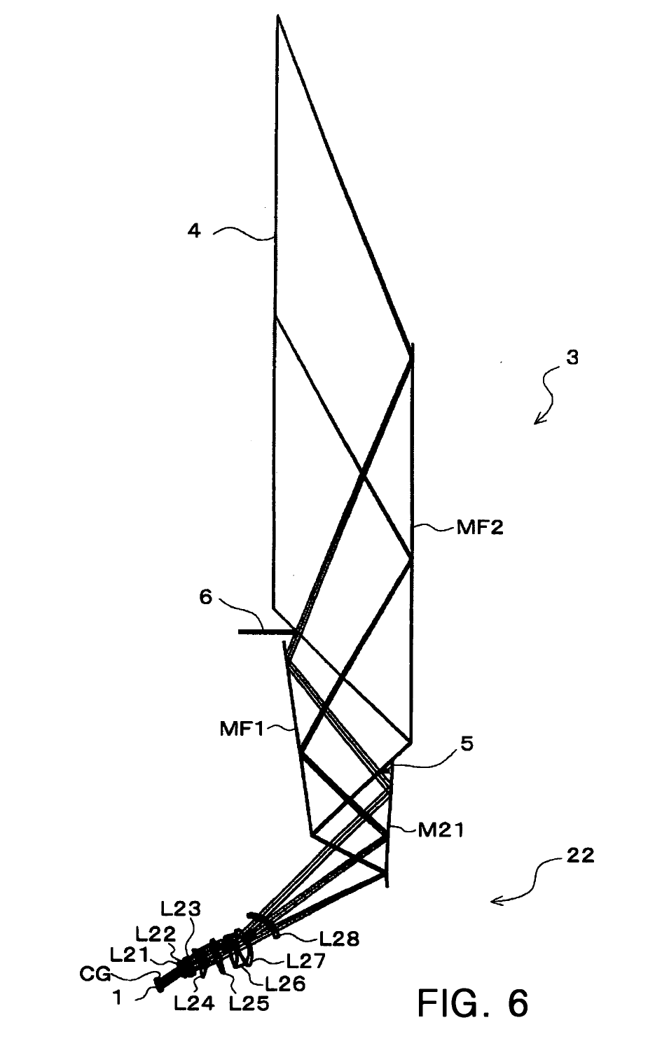

Meanwhile, FIG. 6 is a sectional view illustrating a schematic constitution of the image projecting apparatus using a projecting optical system 22 having only one mirror instead of the projecting optical system 2 having four mirrors. The projecting optical system 22 has lenses L21, L22, L23, L24, L25, L26, L27 and L28 as transmission type optical elements, and a mirror M21 as a reflection type optical element in this order from the reduction side. A diaphragm (not shown) is arranged between the lenses L21 and L22.

The lens 21 is a rotationally symmetrical aspheric lens. The lens 22 is a cemented lens where a negative lens and a positive lens are cemented. The lens 23 is a cemented lens where a positive lens and a negative lens are cemented. The lenses L24 and L25 are positive lenses, and the lens 26 is a cemented lens where a positive lens and a negative lens are cemented. The lens L27 is a negative lens, and the lens L28 is a rotationally asymmetrical aspheric lens with approximately no power. The mirror 21 is a mirror having a curved reflection surface composed of a rotationally symmetrical aspheric surface. In such a projecting optical system 22, the curved reflection surface of the mirror M21 is positioned on the side which is the closest to the optical path bending portion 3 on the optical path of the projecting optical system 22.

Even in the constitutions in FIGS. 5 and 6, the constitution in this embodiment where at least one of the light shielding plates 5 and 6 is arranged can be applied. As a result, the similar effect to the effect such that the ghost light is cut and the deterioration in the quality of the projected image can be avoided can be obtained.

### EXAMPLES

Construction data of the image projecting apparatus in this embodiment are explained below (TABLE 1 to TABLE 67). The following examples 1 to 3 correspond to the image projecting apparatuses in FIGS. 1, 5 and 6 in this embodiment, respectively.

The construction data of the examples show an optical arrangement of the system including a panel display surface So (corresponding to an object surface in enlarged projection) of the light modulating element 1 on the reduction side through a projection surface Si (corresponding to an image surface in enlarged projection) of the screen 4 on the enlargement side. The n-th numbered surface counted from the reduction side is Sn (n=1, 2, 3, . . . ). Surfaces S1 and S2 are both surfaces of the cover glass CG that covers to protect the panel display surface So, and does not compose a part of the projecting optical system.

In the case where a surface vertex is an original point (O) of a local orthogonal coordinate system (X, Y, Z), the arrangement of the optical surfaces is expressed by the original point (O) of the local orthogonal coordinate system (X,Y,Z) in a global orthogonal coordinate system (x,y,z) and coordinate data (x,y,z) of coordinate axis vectors (VX,VY) of an X axis and a Y axis (unit: mm).

All the coordinate systems are defined by a right-handed coordinate system, and the global orthogonal coordinate system (x,y,z) is an absolute coordinate system which matches with the local orthogonal coordinate system (X,Y,Z) of the panel display surface So. The original point (o) of the global orthogonal coordinate system (x,y,z) is, therefore, a point which is the same as the original point (O) which is positioned at the center of the panel display surface So. Further, the vector VX on the panel display surface So is parallel with a surface normal line of the panel display surface So. The vector VY is orthogonal to the vector VX and is parallel with a screen short side of the panel display surface So. Further, as to an optical surface composing a part of a coaxial system where the optical surface expressed by the coordinate data (x,y,z) is a head surface, the arrangement of the optical surface is expressed by an on-axis surface interval T′ (mm) in an X direction on a basis of the previous optical surface.

Surface shapes of the optical elements are expressed by curvatures CO (mm⁻¹) of curvature radius r (mm) and the like of the optical surfaces. A surface Sn with * is a rotationally symmetrical aspheric surface, and its surface shape is defined by the following expression (AS) using the local orthogonal coordinate system (X,Y,Z) where the surface apex is the original point (O). On the other hand, a surface Sn with $ is a rotationally asymmetrical aspheric surface (so-called free curved surface), and its surface shape is defined by the following expression (BS) using the local orthogonal coordinate system (X,Y,Z) where the surface apex is the original point (O). The rotationally symmetrical aspheric surface data and the rotationally asymmetrical aspheric data as well as the other data are shown. A coefficient of a term with no sign is 0, and E-n=×10⁻ⁿ is applied to all the data.
X=(C0−H²)/[1+(1−ε·C0²·H²)^{1/2}]+Σ[A(i)·Hi] (AS)
X=(C0−H²)/[1+(1−ε·C0²·H²)^{1/2}]+Σ[G(j,k)·Y^{j}·Z^{k}] (BS)

In the expressions (AS) and (BS),

X: a shift amount from a reference surface in the X direction in the position of height H (surface apex reference),

H: a height in a direction vertical to the X axis [H=(Y²+Z²)^{1/2}],

CO: curvature at the surface apex (+/−is for the X axis of the local orthogonal coordinate system, and in the case of +, a curvature center is present in a positive direction on the vector VX. CO=1/r),

ε: quadratic surface parameter,

A(i): a coefficient of i-th order rotationally symmetrical aspheric surface,

G(j,k): coefficients of rotationally asymmetrical aspheric surfaces of j-th order of Y and k-th order of Z.

N designates a refractive index with respect to a line d of a medium positioned on the incident side of the optical surfaces, and N′ designates a refractive index with respect to a line d of a medium positioned on the emission side of the optical surfaces. When the optical surface is a reflection surface, N′ obtains a negative value. νd is an Abbe number of an optical material.

When the shape of the panel display surface So is rectangular, a length of the screen short side direction (namely, Y direction) of the panel display surface So is designated by LY, and a length of the screen long side direction (namely, Z direction) of the panel display surface So is designated by LZ. As to the size (mm) of the panel display surface So, in the example 1, LY=±2.754 and LZ=±4.892, and in the examples 2 and 3, LY=±5.0616 and LZ=±8.892. In the example 1, magnification β is 95.03, 75.8673 in the example 2, and 69.5349 in the example 3. FnoY showing F number in a longitudinal direction (Y direction) is 2.83 in the example 1, 3.64 in the example 2, and 3.70 in the example 3. Further, FnoZ showing F number in the lateral direction (Z direction) is 2.81 in the example 1, 3.57 in the example 2 and 3.60 in the example 3.

In the example 1, data about virtual diaphragm are shown at the last part of the construction data. The virtual diaphragm is circular, and its coordinate and the like is shown. The light flux which passes through the optical system defined by the construction data is defined as light flux which passes from the panel display surface So through an edge of the virtual diaphragm. At the time of actual use, the diaphragm is arranged near the position where a principal ray converges.

In the example 2, d=68.9 (mm), and h=768.02 (mm). Therefore, d/h=0.090, so that the conditional expression (1) is satisfied. In the example 2, θ max=75.93 (°), and θ min=56.21(°). Therefore, θ max−θ min=19.72(°), so that the conditional expression (2) is satisfied.

Whereas, in the example 3, d=49.8 (mm), and h=703.92 (mm). Therefore, d/h=0.071, so that the conditional expression (1) is satisfied. Further, in the example 3, θ max=69.9 (°), and θ min=43.66 (°). Therefore, θ max−θ min=26.24(°), so that the conditional expression (2) is satisfied.

This embodiment explains the image projecting apparatus in which the side of the light modulating element 1 is the reduction side, and the side of the screen 4 is the enlargement side, and enlarged projection is performed on the screen from an oblique direction. The constitution of this embodiment using the light shielding plates 5 and 6, however, can be applied to an image reading apparatus where reduced projection is performed. In this case, the panel display surface of the light modulating element 1 may be a light receiving surface of a light receiving element (for example, CCD: Charge Coupled Device) for reading an image, and the projection surface of the screen 4 may be an image surface for reading a projected image (for example, a document surface).

The projecting optical system in this embodiment is composed of the reflection type optical elements and the transmission type optical elements, and uses the mirrors as the reflection type optical elements and the lenses as the transmission type optical elements. As the reflection type optical element, not only the mirrors but also prisms having curved reflection surface and plane reflection surface, for example, may be used. One or a plurality of reflection type optical element(s) having a plurality of reflection surfaces may be used. Further, optical elements having a reflection surface, refracting surface and a diffraction surface, and optical elements having combinations of these surfaces may be used.

On the other hand, in this embodiment, a refracting lens having curved refracting surface is used as the transmission type optical element, but the transmission type optical element to be used is not limited to a refracting lens that deflects an incident light beam using a refracting function (lens which deflects light on an interface between media having different refractive indexes). For example, a diffracting lens that deflects an incident light beam using the diffracting function, a refracting/diffracting hybrid lens that deflects an incident light beam using a combination of the refracting function and the diffracting function, a refractive index distribution type lens that deflects an incident light beam according to refractive index distribution in a medium, and the like may be used.

According to this embodiment, the light shielding member is provided at least one of between the reflection type optical element and the second plane mirror of the projecting optical system, and between the first plane mirror and the screen. As a result, even in the case where oblique projection is performed by using the compact and wider-angle projecting optical system, the ghost light which exerts a bad influence on the projected image is cut appropriately by the light shielding member, so that the deterioration in the quality of the projected image can be avoided.

TABLE 1
(Example 1) So <Panel display surface>
[Coordinates]

O: 0.00000, 0.00000, 0.00000
VX: 1.00000000, 0.00000000, 0.00000000
VY: 0.00000000, 1.00000000, 0.00000000
N = 1.00000, C0 = 0.00000000(r = ∞), N′ = 1.00000, T′ = 0.47

TABLE 2
(Example 1) S1 <Light incident surface of cover glass CG>

N = 1.00000, C0 = 0.00000000(r = ∞), N′ = 1.51872, νd = 64.20,
T′ = 3

TABLE 3
(Example 1) S2 <Light emission surface of cover glass CG>

N = 1.51872, νd = 64.20, C0 = 0.00000000(r = ∞), N′ = 1.00000

TABLE 4
(Example 1) S3 <Light reflection surface of mirror M1>
[Coordinates]

O: 66.73100, −6.90541, 0.00000
VX: 0.99208944, 0.12553305, 0.00000000
VY: −0.12553305, 0.99208944, 0.00000000
N = 1.00000, C0 = −0.01313440(r = −76.1359), N′ = −1.00000

TABLE 5
(Example 1) S4$ <Light incident surface of lens L1>
[Coordinates]

O: 28.05700, −19.34990, 0.00000
VX: −0.96650383, −0.25665219, 0.00000000
VY: −0.25665219, 0.96650383, 0.00000000
N = 1.00000, C0 = 0.00000000(r = ∞)

TABLE 6
(Example 1) S4$ <Light incident surface of lens L1>
[Aspheric surface data]

ε = 1.00000000
G(2, 0) = 0.00132646, G(3, 0) = 0.000125132, G(4, 0) = 2.76467E−6,
G(5, 0) = 1.22670E−6, G(6, 0) = −1.42702E−8, G(7, 0) = −4.35892E−8
G(8, 0) = −1.60876E−9, G(9, 0) = 4.67737E−10, G(10, 0) = 3.15496E−11
G(0, 2) = 0.00115196, G(1, 2) = 8.06295E−5, G(2, 2) = 5.97381E−6,
G(3, 2) = 6.35159E−6, G(4, 2) = −1.40423E−7, G(5, 2) = −3.84613E−7
G(6, 2) = −1.70111E−8, G(7, 2) = 6.10786E−9, G(8, 2) = 4.79200E−10
G(0, 4) = 1.63887E−6, G(1, 4) = 2.62343E−6, G(2, 4) = −2.41050E−8
G(3, 4) = −5.13745E−7, G(4, 4) = −4.28034E−8, G(5, 4) = 1.60064E−8
G(6, 4) = 1.73930E−9,
G(0, 6) = −7.99639E−8, G(1, 6) = −8.50286E−8
G(2, 6) = −1.49506E−8, G(3, 6) = 8.98419E−9, G(4, 6) = 1.56028E−9
G(0, 8) = 1.27328E−9, G(1, 8) = 7.76564E−10, G(2, 8) = 2.66154E−10
G(0, 10) = −7.25034E−12
N′ = 1.52729, νd = 56.38, T′ = 2

TABLE 7
(Example 1) S5 <Light emission surface of lens L1>

N = 1.52729, νd = 56.38, C0 = 0.00000000(r = ∞), N′ = 1.00000

TABLE 8
(Example 1) S6 <Light reflection surface of mirror M2>
[Coordinates]

O: 11.91300, −27.21110, 0.00000
VX: −0.96949879, 0.24509608, 0.00000000
VY: 0.24509608, 0.96949879, 0.00000000
N = 1.00000, C0 = 0.01786840(r = 55.9647), N′ = −1.00000

TABLE 9
(Example 1) S7$ <Light incident surface of lens L2>
[Coordinates]

O: 27.83300, −45.03120, 0.00000
VX: 0.19647910, −0.98050801, 0.00000000
VY: 0.98050801, 0.19647910, 0.00000000
N = 1.00000, C0 = 0.00000000 (r = ∞)

TABLE 10
(Example 1) S7$ <Light incident surface of lens L2>
[Aspheric surface data]

ε = 1.00000000
G(2, 0) = 0.00111659, G(3, 0) = 1.39428E−5, G(4, 0) = −9.22217E−6
G(5, 0) = 3.12188E−7, G(6, 0) = −6.00244E−9, G(7, 0) = 3.93092E−10
G(8, 0) = −3.33434E−11, G(9, 0) = 5.35985E−13,
G(10, 0) = 5.71208E−15
G(0, 2) = −0.000104922, G(1, 2) = −8.88877E−5, G(2, 2) = −1.26514E−5
G(3, 2) = 8.62600E−7, G(4, 2) = −4.24585E−9, G(5, 2) = −1.55424E−10
G(6, 2) = −9.27806E−11, G(7, 2) = 5.71962E−12,
G(8, 2) = −8.84483E−14
G(0, 4) = 5.90316E−7, G(1, 4) = 5.69680E−7, G(2, 4) = 8.24467E−9
G(3, 4) = −3.104750E−9, G(4, 4) = −2.34340E−11,
G(5, 4) = 1.35195E−11
G(6, 4) = −4.54161E−13,
G(0, 6) = −5.77230E−9, G(1, 6) = −7.35487E−10,
G(2, 6) = −3.01533E−11,
G(3, 6) = 8.05603E−12, G(4, 6) = −3.75698E−13
G(0, 8) = 1.73737E−11, G(1, 8) = 4.69614E−13, G(2, 8) = 6.74370E−14
G(0, 10) = −2.33801E−14
N′ = 1.52729, νd = 56.38, T′ = 3

TABLE 11
(Example 1) S8 <Light emission surface of lens L2>

N′ = 1.52729, νd = 56.38, C0 = 0.00000000(r = ∞), N′ = 1.00000

TABLE 12
(Example 1) S9$ <Light reflection surface of mirror M3>
[Coordinates]

O: 68.23100, −76.48330, 0.00000
VX: 0.98334518, −0.18174776, 0.00000000
VY: 0.18174776, 0.98334518, 0.00000000
N = 1.00000, C0 = −0.00366288(r = −273.0092)

TABLE 13
(Example 1) S9$ <Light reflection surface of mirror M3>
[Aspheric surface data]

ε = −21.5073000
G(2, 0) = −0.000878161, G(3, 0) = −3.18630E−5, G(4, 0) = −2.53494E−7
G(5, 0) = 9.79490E−10, G(6, 0) = −2.86615E−10,
G(7, 0) = −1.63847E−11
G(8, 0) = −3.92457E−13, G(9, 0) = −4.71822E−15,
G(10, 0) = −2.33479E−17
G(0, 2) = −0.00193231, G(1, 2) = −4.47720E−5, G(2, 2) = 3.86217E−7
G(3, 2) = 2.59624E−8, G(4, 2) = 9.79306E−11, G(5, 2) = −7.48206E−12
G(6, 2) = −7.74672E−14, G(7, 2) = 1.30923E−15, G(8, 2) = 1.99862E−17
G(0, 4) = 6.79363E−7, G(1, 4) = 1.41819E−8, G(2, 4) = −6.15793E−10
G(3, 4) = −3.37127E−11, G(4, 4) = −5.25839E−13,
G(5, 4) = −1.37773E−15
G(6, 4) = 1.95558E−17,
G(0, 6) = −8.13949E−11, G(1, 6) = 3.33414E−12
G(2, 6) = 6.19270E−13, G(3, 6) = 2.22238E−14, G(4, 6) = 2.33080E−16
G(0, 8) = 5.60263E−14, G(1, 8) = 1.79605E−15, G(2, 8) = 1.49730E−17
G(0, 10) = −1.23359E−17
N′ = −1.00000

TABLE 14
(Example 1) S10$ <Light reflection surface of mirror M4>
[Coordinates]

O: −12.73800, −97.41020, 0.00000
VX: −0.92304666, −0.38468800, 0.00000000
VY: −0.38468800, 0.92304666, 0.00000000
N = 1.00000, C0 = 0.05630990(r = 17.7589)

TABLE 15
(Example 1) S10$ <Light reflection surface of mirror M4>
[Aspheric surface data]

ε = −2.91717000
G(2, 0) = −0.00728876, G(3, 0) = 0.000140657, G(4, 0) = 1.50391E−6
G(5, 0) = 8.80045E−9, G(6, 0) = −6.20290E−11, G(7, 0) = −1.91415E−12
G(8, 0) = 5.07027E−15, G(9, 0) = 4.97902E−16, G(10, 0) = 3.86965E−18
G(0, 2) = 0.00331322, G(1, 2) = −4.19539E−5, G(2, 2) = −6.25065E−6
G(3, 2) = −1.41784E−7, G(4, 2) = −9.49099E−10, G(5, 2) = 6.61922E−12
G(6, 2) = 4.37632E−14, G(7, 2) = −1.55322E−15,
G(8, 2) = −1.40102E−17
G(0, 4) = −1.98165E−6, G(1, 4) = −3.08305E−8, G(2, 4) = 1.49750E−9
G(3, 4) = 4.20198E−11, G(4, 4) = 7.92015E−14, G(5, 4) = −6.28944E−15
G(6, 4) = −5.13279E−17,
G(0, 6) = 6.44830E−10, G(1, 6) = 1.34506E−11,
G(2, 6) = −4.06334E−13,
G(3, 6) = −1.51590E−14, G(4, 6) = −1.06133E−16
G(0, 8) = −1.50579E−13, G(1, 8) = −3.12475E−15,
G(2, 8) = −6.04073E−17
G(0, 10) = 4.60011E−17
N′ = −1.00000

TABLE 16
(Example 1) S11 <Light reflection surface of first plane mirror MF1>
[Coordinates]

O: 66.15500, −233.43800, 0.00000
VX: 0.98872621, 0.14973468, 0.00000000
VY: −0.14973468, 0.98872621, 0.00000000
N = 1.00000, C0 = 0.00000000(r = ∞), N′ = −1.00000

TABLE 17
(Example 1) S12 <Light reflection surface of second plane mirror MF2>
[Coordinates]

O: −30.78200, −503.11200, 0.00000
VX: −0.99968436, −0.02512327, 0.00000000
VY: −0.02512327, 0.99968436, 0.00000000
N = 1.00000
C0 = C0 = 0.00000000(r = ∞)
N′ = −1.00000

TABLE 18
(Example 1) Si <Screen projection surface>
[Coordinates]

O: 91.38568, −587.86200, 0.00000
VX: 0.99968436, 0.02512327, 0.00000000
VY: 0.02512327, −0.99968436, 0.00000000

TABLE 19
(Example 1) <Virtual diaphragm data>
[Coordinates]

O: 100400.00000, −10552.50000, 0.00000
VX: 1.00000000, 0.00000000, 0.00000000
VY: 0.00000000, 1.00000000, 0.00000000
N = 1.00000, C0 = 0.00000000(r = ∞), N′ = 1.00000

TABLE 20
(Example 2) So <Panel display surface>
[Coordinates]

O: 0.00000, 0.00000, 0.00000
VX: 1.00000000, 0.00000000, 0.00000000
VY: 0.00000000, 1.00000000, 0.00000000
N = 1.00000, C0 = 0.00000000(r = ∞), N′ = 1.00000, T′ = 0.5

TABLE 21
(Example 2) S1 <Light incident surface of cover glass CG>

N = 1.00000, C0 = 0.00000000(r = ∞), N′ = 1.51045, νd = 61.19,
T′ = 3

TABLE 22
(Example 2) S2 <Light emission surface of cover glass CG>

N = 1.51045, νd = 61.19, C0 = 0.00000000(r = ∞), N′ = 1.00000

TABLE 23
(Example 2) S3* <Light incident surface of lens L11>

[Coordinates]
O: 33.20000, 0.37770, 0.00000
VX: 0.99970884, −0.02412951, 0.00000000
VY: 0.02412951, 0.99970884, 0.00000000
N = 1.00000, C0 = 0.01163429(r = 85.9528)
[Aspheric surface data]
ε = 1.00000000
A(4) = −3.08945486E−5, A(6) = −1.69854691E−7,
A(8) = 2.98237817E−9 A(10) = −2.87260782E−11
N′ = 1.77064, νd = 45.55, T′ = 2

TABLE 24
(Example 2) S4 <Light emission surface of lens L11>

N = 1.77064, νd = 45.55, C0 = 0.00000000(r = ∞), N′ = 1.00000,
T′ = 0.759492

TABLE 25
(Example 2) S5 <diaphragm>

N = 1.00000, C0 = 0.00000000(r = ∞), N′ = 1.00000, T′ = 3.43812

TABLE 26
(Example 2) S6 <Light incident surface of lens L12>

N = 1.00000, C0 = −0.01612355(r = −62.0211), N′ = 1.78478,
νd = 26.33, T′ = 3

TABLE 27
(Example 2) S7 <bonded surface of lens 12>

N = 1.78478, νd = 26.33, C0 = 0.05675606(r = 17.6193),
N′ = 1.63912, νd = 56.10, T′ = 4.4604

TABLE 28
(Example 2) S8 <Light emission surface of lens L12>

N = 1.63912, νd = 56.10, C0 = −0.02877877(r = −34.7478),
N′ = 1.00000, T′ = 8.07107

TABLE 29
(Example 2) S9 <Light incident surface of lens L13>

N = 1.00000, C0 = 0.00045619(r = 2192.0700), N′ = 1.61398, νd = 36.44
T′ = 7.9667

TABLE 30
(Example 2) S10 <Light emission surface of lens L13>

N = 1.61398, νd = 36.44, C0 = −0.04527568(r = −22.0869), N′ = 1.00000
T′ = 30.464

TABLE 31
(Example 2) S11 <Light incident surface of lens L14>

N = 1.00000, C0 = −0.05191988(r = −19.2604), N′ = 1.81359, νd = 36.44
T′ = 2.5

TABLE 32
(Example 2) S12 <Light emission surface of lens L14>

N = 1.81359, νd = 36.44, C0 = −0.02453932(r = −40.7509), N′ = 1.00000
T′ = 14.0521

TABLE 33

(Example 2) S13$ <Light incident surface of lens L15>
N = 1.00000, C0 = −0.00975490(r = −102.5126)
[Aspheric surface data]
ε = 1.00000000
G(2, 0) = −0.000704919616, G(3, 0) = 0.000165579062
G(4, 0) = −1.06291352E−5, G(5, 0) = 2.62435599E−7
G(6, 0) = 1.14866774E−8, G(7, 0) = −5.28576420E−10
G(8, 0) = −4.20172500E−11, G(9, 0) = 2.67353071E−12
G(10, 0) = −3.91365948E−14
G(0, 2) = −0.000266039134, G(1, 2) = 0.000138335742
G(2, 2) = −8.82980350E−6, G(3, 2) = −3.68763764E−7
G(4, 2) = 7.77341670E−8, G(5, 2) = −2.04184030E−9
G(6, 2) = −2.03057180E−10, G(7, 2) = 1.27216128E−11
G(8, 2) = −1.97410880E−13,
G(0, 4) = 1.78366041E−6, G(1, 4) = −7.30246855E−7
G(2, 4) = 8.73974571E−8, G(3, 4) = −3.42298694E−9
G(4, 4) = −1.35285070E−10, G(5, 4) = 1.32326360E−11
G(6, 4) = −2.42765133E−13,
G(0, 6) = −3.61547265E−9, G(1, 6) = 1.51916107E−9
G(2, 6) = −1.92236195E−10, G(3, 6) = 1.07974316E−11
G(4, 6) = −2.18196579E−13,
G(0, 8) = −4.52104347E−13, G(1, 8) = −4.89544026E−13
G(2, 8) = 2.14785190E−14
G(0, 10) = 4.78735733E−15
N′ = 1.52729, νd = 56.38, T′ = 3.4

TABLE 34
(Example 2) S14 <Light emission surface of lens L15>

N = 1.52729, νd = 56.38, C0 = −0.01007753(r = −99.2307), N′ = 1.00000

TABLE 35
(Example 2) S15* <Light reflection surface of mirror M11>

[Coordinates]
O: 152.55096, −10.35426, 0.00000
VX: 0.92663209, −0.37596938, 0.00000000
VY: 0.37596938, 0.92663209, 0.00000000
N = 1.00000, C0 = −0.00483113(r = −206.9911)
[Aspheric surface data]
ε = −2.52952291
A(4) = 9.55990507E−7, A(6) = −2.29605438E−10,
A(8) = 2.79383985E−14
A(10) = −1.35003718E−18
N′ = −1.00000

TABLE 36
(Example 2) S16$ <Light reflection surface of mirror M12>
[Coordinates]

O: 100.71219, 31.29259, 0.00000
VX: −0.78457167, 0.62003814, 0.00000000
VY: 0.62003814, 0.78457167, 0.00000000
N = 1.00000, C0 = 0.04364309(r = 22.9131)

TABLE 37
(Example 2) S16$ <Light reflection surface of mirror M12>
[Aspheric surface data]

ε = −1.74036193
G(2, 0) = −0.00118376352, G(3, 0) = −7.69008628E−6,
G(4, 0) = 4.06090411E−8, G(5, 0) = 2.24870471E−10
G(6, 0) = −5.45283166E−13, G(7, 0) = −7.74976957E−15
G(8, 0) = 7.99738170E−18, G(9, 0) = −3.57661273E−20
G(10, 0) = 6.22764864E−22
G(0, 2) = −0.00147418107
G(1, 2) = −2.44420714E−6, G(2, 2) = −1.44576907E−8
G(3, 2) = 9.32083655E−10, G(4, 2) = −1.23497312E−12
G(5, 2) = −3.41409000E−14, G(6, 2) = 3.36355244E−17
G(7, 2) = −3.25750939E−19, G(8, 2) = 5.23694650E−21
G(0, 4) = 3.15421469E−9, G(1, 4) = 6.34627255E−10
G(2, 4) = −5.28979445E−12, G(3, 4) = −4.39013091E−14
G(4, 4) = 3.47237906E−16, G(5, 4) = 1.53887334E−18
G(6, 4) = −9.79397825E−21,
G(0, 6) = −8.50955294E−12, G(1, 6) = 1.47647924E−13,
G(2, 6) = −2.92124183E−16, G(3, 6) = −1.12156633E−18,
G(4, 6) = −9.86954578E−21
G(0, 8) = 1.24003124E−15, G(1, 8) = −3.13508404E−17
G(2, 8) = 1.50816722E−19
G(0, 10) = 2.89628271E−20
N′ = −1.00000

TABLE 38
(Example 2) S17 <Light reflection surface of first plane mirror MF1>
[Coordinates]

O: 238.38001, 164.43476, 0.00000
VX: 0.83759424, −0.54629285, 0.00000000
VY: 0.54629285, 0.83759424, 0.00000000
N = 1.00000, C0 = 0.00000000(r = ∞), N′ = −1.00000

TABLE 39
(Example 2) S18 <Light reflection surface of second plane mirror MF2>
[Coordinates]

O: 286.23334, 464.77735, 0.00000
VX: −0.87063163, 0.49193552, 0.00000000
VY: 0.49193552, 0.87063163, 0.00000000
N = 1.00000, C0 = 0.00000000(r = ∞), N′ = −1.00000

TABLE 40
(Example 2) Si <Screen projection surface>
[Coordinates]

O: −13.61638, −727.63091, 0.00000
VX: −0.99961537, −0.02773278, 0.00000000
VY: 0.02773278, −0.99961537, 0.00000000

TABLE 41
(Example 3) So <Panel display surface>
[Coordinates]

O: 0.00000, 0.00000, 0.00000
VX: 1.00000000, 0.00000000, 0.00000000
VY: 0.00000000, 1.00000000, 0.00000000
N = 1.00000, C0 = 0.00000000(r = ∞), N′ = 1.00000, T′ = 0.5

TABLE 42
(Example 3) S1 <Light incident surface of cover glass CG>

N = 1.00000, C0 = 0.00000000(r = ∞), N′ = 1.51045, νd = 61.19,
T′ = 3

TABLE 43
(Example 3) S2 <Light emission surface of cover glass CG>

N = 1.51045, νd = 61.19, C0 = 0.00000000(r = ∞), N′ = 1.00000

TABLE 44
(Example 3) S3* <Light incident surface of lens L21>

[Coordinates]
O: 33.20000, 0.52376, 0.00000
VX: 0.99974238, −0.02269753, 0.00000000
VY: 0.02269753, 0.99974238, 0.00000000
N = 1.00000, C0 = −0.03120243(r = −32.0488)
[Aspheric surface data]
ε = 1.00000000
A(4) = −5.90605911E−5, A(6) = −2.71749917E−7, A(8) =
4.09983339E−9
A(10) = −5.57568275E−11
N′ = 1.77638, νd = 27.20, T′ = 2.0035

TABLE 45
(Example 3) S4 <Light emission surface of lens L21>

N = 1.77638, νd = 27.20, C0 = 0.00000000(r = ∞), N′ = 1.00000, T′ = 0

TABLE 46
(Example 3) S5 <diaphragm>

N = 1.00000, C0 = 0.00000000(r = ∞), N′ = 1.00000, T′ = 1.31148

TABLE 47
(Example 3) S6 <Light incident surface of lens L22>

N = 1.00000, C0 = 0.01562647(r = 63.9940), N′ = 1.76109, νd = 27.18,
T′ = 1.20058

TABLE 48
(Example 3) S7 <bonded surface of lens L22>

N = 1.76109, νd = 27.18, C0 = 0.04524503(r = 22.1019),
N′ = 1.75491, νd = 52.14, T′ = 3.66711

TABLE 49
(Example 3) S8 <Light emission surface of lens L22>

N = 1.75491, νd = 52.14, C0 = −0.05766619(r = −17.3412), N′ = 1.00000
T′ = 0.298118

TABLE 50
(Example 3) S9 <Light incident surface of lens L23>

N = 1.00000, C0 = −0.02841175(r = −35.1967), N′ = 1.61518,
νd = 36.31,
T′ = 3.84278

TABLE 51
(Example 3) S10 <bonded surface of lens L23>

N = 1.61518, νd = 36.31, C0 = −0.09316716(r = −10.7334),
N′ = 1.79321, νd = 26.06, T′ = 1.8

TABLE 52
(Example 3) S11 <Light emission surface of lens L23>

N = 1.79321, νd = 26.06, C0 = 0.00952410(r = 104.9968), N′ = 1.00000,
T′ = 9.15513

TABLE 53
(Example 3) S12 <Light incident surface of lens L24>

N = 1.00000, C0 = −0.01079619(r = −92.6253),
N′ = 1.80927, νd = 25.56, T′ = 7.10731

TABLE 54
(Example 3) S13 <Light emission surface of lens L24>

N = 1.80927, νd = 25.56, C0 = −0.04275071(r = −23.3914), N′ = 1.00000
T′ = 13.3791

TABLE 55
(Example 3) S14 <Light incident surface of lens L25>

N = 1.00000, C0 = 0.01077861(r = 92.7764),
N′ = 1.80681, νd = 28.16, T′ = 5.2

TABLE 56
(Example 3) S15 <Light emission surface of lens L25>

N = 1.80681, νd = 28.16, C0 = −0.00500527(r = −199.7893),
N′ = 1.00000 T′ = 13.0492

TABLE 57
(Example 3) S16 <Light incident surface of lens L26>

N = 1.00000, C0 = 0.00038365(r = 2606.5218), N′ = 1.75386,
νd = 52.25, T′ = 7.68826

TABLE 58
(Example 3) S17 <bonded surface of lens L26>

N = 1.75386, νd = 52.25, C0 = −0.03411557(r = −29.3121)
N′ = 1.77159, νd = 26.79, T′ = 2.94078

TABLE 59
(Example 3) S18 <Light emission surface of lens L26>

N = 1.77159, νd = 26.79, C0 = 0.01860106(r = 53.7604), N′ = 1.00000
T′ = 12.6573

TABLE 60
(Example 3) S19 <Light incident surface of lens L27>

N = 1.00000, C0 = −0.04776031(r = −20.9379), N′ = 1.79171, νd = 26.10
T′ = 3

TABLE 61
(Example 3) S20 <Light emission surface of lens L27>

N = 1.79171, νd = 26.10, C0 = −0.02811823(r = −35.5641),
N′ = 1.00000, T′ = 30.8302

TABLE 62

(Example 3) S21$ <Light incident surface of lens L28>
N = 1.00000, C0 = −0.02932993(r = −34.0949)
[Aspheric surface data]
ε = 1.00000000
G(2, 0) = 0.000531360278, G(3, 0) = 2.88095919E−5
G(4, 0) = −3.47968400E−6, G(5, 0) = 3.59230926E−8
G(6, 0) = 1.45515392E−9, G(7, 0) = −4.08886074E−11
G(8, 0) = −1.53652231E−13, G(9, 0) = 7.71773568E−15
G(10, 0) = −1.59895780E−16
G(0, 2) = 0.000588508687, G(1, 2) = 2.54697110E−5
G(2, 2) = −3.09115193E−6, G(3, 2) = −1.49555805E−7
G(4, 2) = 1.02398516E−8, G(5, 2) = −1.35351791E−10
G(6, 2) = −1.24601650E−12, G(7, 2) = −5.07736637E−14,
G(8, 2) = 1.00923527E−15
G(0, 4) = −6.12497020E−7, G(1, 4) = −1.03030103E−7
G(2, 4) = 6.39027845E−9, G(3, 4) = 4.81182122E−11
G(4, 4) = −7.09442936E−12, G(5, 4) = −1.44507262E−13
G(6, 4) = 5.86327137E−15,
G(0, 6) = 5.03036466E−10, G(1, 6) = 1.18773933E−10,
G(2, 6) = −9.97153071E−12, G(3, 6) = 1.12788823E−13,
G(4, 6) = 2.34108101E−15
G(0, 8) = −1.65200776E−12, G(1, 8) = −5.46121788E−14
G(2, 8) = 4.34100363E−15
G(0, 10) = 1.20305385E−15
N′ = 1.52729, νd = 56.38, T′ = 5

TABLE 63
(Example 3) S22 <Light emission surface of lens L28>

N = 1.52729, νd = 56.38, C0 = −0.02660134(r = −37.5921), N′ = 1.00000

TABLE 64
(Example 3) S23$ <Light reflection surface of mirror M21>

[Coordinates]
O: 295.52060, −13.46506, 0.00000
VX: 0.99861593, −0.05259487, 0.00000000
VY: 0.05259487, 0.99861593, 0.00000000
N = 1.00000, C0 = 0.01236714(r = 80.8595)
[Aspheric surface data]
ε = −4.59296886
A(4) = −2.16422720E−8, A(6) = 1.00518643E−12,
A(8) = −2.98750271E−17, A(10) = 5.04219213E−22,
A(12) = −3.61772802E−27
N′ = −1.00000

TABLE 65
(Example 3) S24 <Light reflection surface of first plane mirror MF1>
[Coordinates]

O: 257.41195, 191.61954, 0.00000
VX: −0.97753162, 0.21078883, 0.00000000
VY: 0.21078883, 0.97753162, 0.00000000
N = 1.00000, C0 = 0.00000000(r = ∞), N′ = −1.00000

TABLE 66
(Example 3) S25 <Light reflection surface
of SECOND plane mirror MF2>
[Coordinates]

O: 463.30474, 360.85577, 0.00000
VX: 0.93411159, −0.35698114, 0.00000000
VY: 0.35698114, 0.93411159, 0.00000000
N = 1.00000, C0 = 0.00000000(r = ∞), N′ = −1.00000

TABLE 67
(Example 3) Si <Screen projection surface>
[Coordinates]

O: 412.55325, 690.26377, 0.00000
VX: −0.93411159, 0.35698114, 0.00000000
VY: −0.35698114, −0.93411159, 0.00000000

What is claimed is:

1. An image projecting apparatus comprising:
a projecting optical system for emitting an image light to a screen, including a reflection type optical element having a curved reflection surface on a side closest to the screen on an optical path thereof;
a first plane mirror for reflecting the image light emitted from the projecting optical system so as to lead the image light to the screen;
a second plane mirror arranged on an optical path on the screen side of the first plane mirror for reflecting the image light reflected by the first plane mirror; and
a light shielding member arranged between the reflection type optical element and the second plane mirror for shielding a light unnecessary for an image projection.

2. The image projecting apparatus according to claim 1, wherein the second plane mirror has a portion which is opposed to both the screen and the first plane mirror between an upper end of the screen and a lower end of the first plane mirror.

3. The image projecting apparatus according to claim 1, wherein the light shielding member shields a light that deviates from the optical path entering the first plane mirror and enters the screen in the image light which is emitted from the curved reflection surface of the projecting optical system.

4. The image projecting apparatus according to claim 1, wherein when in the image light which enters the screen from the curved reflection surface via the first plane mirror and the second plane mirror, light which enters a side of the screen which is the closest to the first plane mirror is first light, and light which enters the opposite side of the screen to the first plane mirror is second light, the light shielding member is provided outside the optical path with respect to a position where a light advancing from the first plane mirror to the second plane mirror in the first light intersects with a light advancing from the curved reflection surface to the first plane mirror in the second light.

5. The image projecting apparatus according to claim 4, wherein the light shielding member is provided so as to be the closest to the first plane mirror.

6. The image projecting apparatus according to claim 1, wherein when an intersection point between an extended line of the image light entering the first plane mirror which is the closest to the screen from the curved reflection surface and a plane including a projection surface of the screen is designated by A, and a shortest distance between the intersection point A and the screen is designated by d and a length of the screen in the direction of the distance d is designated by h, the following conditional expression is satisfied:
0.02<d/h<0.5.

7. The image projecting apparatus according to claim 1, wherein when in an angle between a normal line on the projection surface of the screen and image light entering the screen from the second plane mirror, a maximum angle is designated by θ max (°) and a minimum angle is designated by θ min (°), the following conditional expression is satisfied:
10<θ max−θ min<50.

8. An image projecting apparatus comprising:
a projecting optical system for emitting an image light to a screen, including a reflection type optical element having a curved reflection surface on a side which is the closest to the screen on an optical path thereof;
a first plane mirror for reflecting the image light emitted from the projecting optical system so as to lead the reflected light to the screen;
a second plane mirror for reflecting the image light reflected by the first plane mirror, arranged on an optical path on the screen side of the first plane mirror; and
a light shielding member arranged between the first plane mirror and the screen for shielding light unnecessary for image projection.

9. The image projecting apparatus according to claim 8, wherein the second plane mirror has a portion which is opposed to both the screen and the first plane mirror between an upper end of the screen and a lower end of the first plane mirror.

10. The image projecting apparatus according to claim 8, wherein the light shielding member shields light which deviates from the optical path entering the first plane mirror so as to enter the screen in the image light emitted from the curved reflection surface of the projecting optical system.

11. The image projecting apparatus according to claim 8, wherein when in the image light which enters the screen from the curved reflection surface via the first plane mirror and the second plane mirror, light which enters a side of the screen which is the closest to the first plane mirror is first light and light which enters an opposite side of the screen to the first plane mirror is second light,
the light shielding member is provided outside the optical path with respect to a position where light which advances from the second plane mirror to the screen in the first light intersects with light which advances from the first plane mirror to the second plane mirror in the second light.

12. The image projecting apparatus according to claim 11, wherein the light shielding member is provided on a side which is the closest to the second plane mirror.

13. The image projecting apparatus according to claim 8, wherein when an intersection point between an extended line of the image light entering the side of the first plane mirror which is the closest to the screen from the curved reflection surface and a plane including a projection surface of the screen is designated by A, a shortest distance between the intersection point A and the screen is designated by d and a height of the screen in the direction of the distance d is designated by h, the following conditional expression is satisfied:
0.02<d/h<0.5.

14. The image projecting apparatus according to claim 6, wherein when in an angle between a normal line on the projection surface of the screen and the image light entering the screen from the second plane mirror, a maximum angle is designated by θ max (°) and a minimum angle is designated by θ min (°), the following conditional expression is satisfied:
10<θ max−θ min<50.

15. An image projecting apparatus comprising:
a projecting optical system for emitting an image light including a reflection type optical element having a curved reflection surface on a side which is the closest to a screen on an optical path thereof;
a first plane mirror for reflecting the image light emitted from the projecting optical system so as to lead the reflected light to the screen;
a second plane mirror arranged on an optical path on the screen side of the first plane mirror for reflecting the image light reflected by the first plane mirror;
a first light shielding member arranged between the reflection type optical element and the second plane mirror for shielding light unnecessary for image projection; and
a second light shielding member arranged between the first plane mirror and the screen for shielding light unnecessary for image projection.

16. The image projecting apparatus according to claim 15, wherein the second plane mirror has a portion which is opposed to both the screen and the first plane mirror between an upper end of the screen and a lower end of the first plane mirror.

17. The image projecting apparatus according to claim 15, wherein the first light shielding member shields light which deviates from the optical path entering the first plane mirror so as to enter the screen in the image light emitted from the curved reflection surface of the projecting optical system.

18. The image projecting apparatus according to claim 15, wherein the second light shielding member shields light which deviates from the optical path entering the first plane mirror so as to enter the screen in the image light emitted from the curved reflection surface of the projecting optical system.

19. The image projecting apparatus according to claim 15, wherein when in the image light which enters the screen from the curved reflection surface via the first plane mirror and the second plane mirror, light which enters a side of the screen which is the closest to the first plane mirror is first light and light which enters an opposite side of the screen to the first plane mirror is second light,
the first light shielding member is provided outside the optical path with respect to a position where the first light which advances from the first plane mirror to the second plane mirror intersects with the second light which advances from the curved reflection surface to the first plane mirror.

20. The image projecting apparatus according to claim 15, wherein when in the image light which enters the screen from the curved reflection surface via the first plane mirror and the second plane mirror, light which enters a side of the screen which is the closest to the first plane mirror is first light and light which enters an opposite side of the screen to the first plane mirror is second light,
the second light shielding member is provided outside the optical path with respect to a position where the first light which advances from the second plane mirror to the screen intersects with the second light which advances from the first plane mirror to the second plane mirror.

21. The image projecting apparatus according to claim 19, wherein the first light shielding member is provided on a side which is the closest to the first plane mirror.

22. The image projecting apparatus according to claim 20, wherein the second light shielding member is provided on a side which is the closest to the second plane mirror.

23. The image projecting apparatus according to claim 15, wherein when an intersection point between an extended line of the image light entering the side of the first plane mirror which is the closest to the screen from the curved reflection surface and a plane including a projection surface of the screen is designated by A, a shortest distance between the intersection point A and the screen is designated by d and a height of the screen in the direction of the distance d is designated by h, the following conditional expression is satisfied:
0.02<d/h<0.5.

24. The image projecting apparatus according to claim 15, wherein when in an angle between a normal line on the projection surface of the screen and the image light entering the screen from the second plane mirror, a maximum angle is designated by θ max (°) and a minimum angle is designated by θ min (°), the following conditional expression is satisfied:
10<θ max−θ min<50.
